(19) United States
(12) Patent Application Publication
(10) Pub. No.: US 2020/0153979 A1
(43) Pub. Date: May 14, 2020

(54) IMAGE READING APPARATUS THAT READS DOCUMENT AND GENERATES IMAGE DATA

(71) Applicant: KYOCERA Document Solutions Inc., Osaka (JP)

(72) Inventor: Christian GELBOLINGO, Osaka (JP)

(73) Assignee: KYOCERA Document Solutions Inc., Osaka (JP)

(21) Appl. No.: 16/674,388

(22) Filed: Nov. 5, 2019

(30) Foreign Application Priority Data
Nov. 9, 2018 (JP) 2018-211615

(51) Int. Cl. H04N 1/00; G06Q 10/10

(52) U.S. Cl. CPC H04N 1/00212; H04N 1/00339; G06Q 10/107

(57) ABSTRACT

An image reading apparatus includes an image reading device, a communication device, and a control device. The image reading device reads a source document and generates image data. The communication device communicates with an information processing apparatus via a network. The control device includes a processor, and acts as a controller that generates a first image file based on the image data, when the processor executes a control program. When the image data includes code data corresponding to a code indicating a destination of the image file, the controller generates a second image file by deleting the code data from the image data, and transmits the second image file to the destination indicated by the code, and acquired from the code data, through the communication device.

### INCORPORATION BY REFERENCE

This application claims priority to Japanese Patent Application No. 2018-211615 filed on Nov. 9, 2018, the entire contents of which are incorporated by reference herein.

### BACKGROUND

The present disclosure relates to an image reading apparatus, and in particular to a technique to transmit an image file.

A technique is known to transmit an image file generated through a scanning function, to a destination designated by a user. For example, a scanner device is known that checks an e-mail address inputted through an operation panel, according to predetermined criteria, and transmits a scanned file only to the e-mail address that satisfies the criteria.

### SUMMARY

The disclosure proposes further improvement of the foregoing technique. In an aspect, the disclosure provides an image reading apparatus including an image reading device, a communication device, and a control device. The image reading device reads a source document and generates image data. The communication device communicates with an information processing apparatus via a network. The control device includes a processor, and acts as a controller that generates a first image file based on the image data, when the processor executes a control program. When the image data includes code data corresponding to a code indicating a destination of the image file, the controller generates a second image file by deleting the code data from the image data, and transmits the second image file to the destination indicated by the code, and acquired from the code data, through the communication device.

### BRIEF DESCRIPTION OF THE DRAWINGS

FIG. 1 is a perspective view showing an appearance of an image forming apparatus including an image reading apparatus according to an embodiment of the disclosure.

FIG. 2 is a block diagram showing an internal configuration of the image forming apparatus including the image reading apparatus according to the embodiment of the disclosure.

FIG. 3 is a flowchart showing an e-mail transmission process.

FIG. 4 is a schematic drawing showing an example of a home screen.

FIG. 5 is a schematic drawing showing a display format of a transmission screen.

FIG. 6 is a schematic drawing showing an example of a source document including a two-dimensional code.

FIG. 7 is a schematic drawing showing an example of an authentication screen.

FIG. 8 is a schematic drawing showing another display format of the transmission screen.

### DETAILED DESCRIPTION

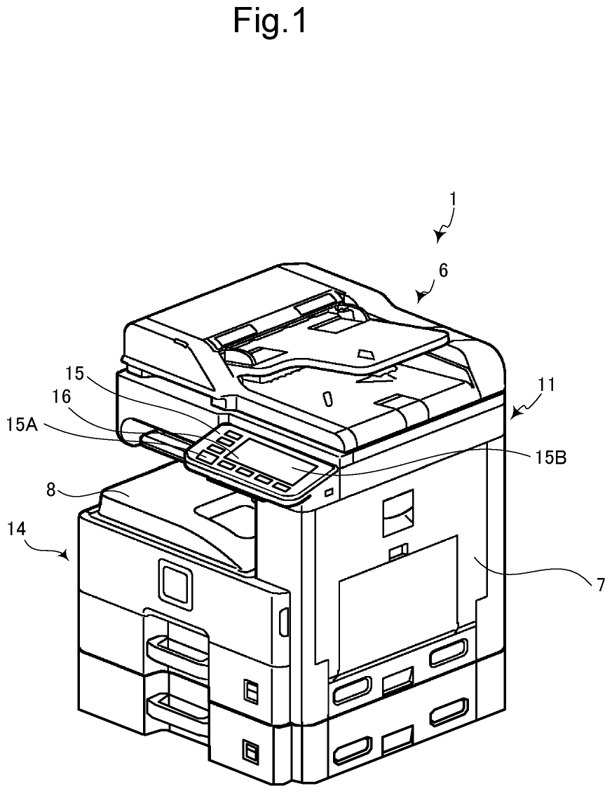

Hereafter, an image reading apparatus according to an embodiment of the disclosure will be described, with reference to the drawings. FIG. 1 is a perspective view showing an appearance of an image forming apparatus including the image reading apparatus according to the embodiment of the disclosure. Referring to FIG. 1, the image forming apparatus 1 is a multifunction peripheral having a plurality of functions such as a facsimile function, a copying function, a printing function, and a scanning function. The image forming apparatus 1 also possesses an e-mail transmission function, to transmit an image file generated by the scanning function, as an attached file added to e-mail data.

The image forming apparatus 1 shown in FIG. 1 includes, inside a casing 7, a plurality of components for realizing various functions of the image forming apparatus 1. For example, an image reading device 11, an image forming device 12 (not shown in FIG. 1), a fixing device 13 (not shown in FIG. 1), and a paper feed device 14 are provided inside the casing 7.

The image reading device 11 is an automatic document feeder (ADF) including a document transport device 6 that transports source documents, and a scanner that optically reads the document transported by the document transport device 6, or placed on a platen glass. The image reading device 11 emits light from a light emitter to the document, and receives the reflected light with a charge-coupled device (CCD), to thereby read the image on the document and generate image data representing the document image.

The image forming device 12 includes a photoconductor drum, a charging device, an exposure device, a developing device, and a transfer device. The image forming device 12 forms an image based on a toner image, on a recording sheet delivered from the paper feed device 14, according to the image data generated by the image reading device 11, image data received from a personal computer (hereinafter, PC) connected via a network, or image data received from another facsimile machine.

The fixing device 13 heats and presses the recording sheet, on which the toner image has been formed by the image forming device 12, thereby fixing the toner image onto the recording sheet. The recording sheet with the toner image fixed thereon by the fixing device 13 is discharged to an output tray 8.

The paper feed device 14 draws out the recording sheets stocked in a paper cassette or placed on a manual bypass tray, one by one with a pickup roller, and delivers the recording sheet to the image forming device 12.

The image forming apparatus 1 includes an operation device 15. The operation device 15 is operated by the user, to input instructions with respect to the functions that the image forming apparatus 1 is configured to perform. The operation device 15 includes, as an example of hard keys, a start key 15A for instructing the execution of the function. The operation device 15 also includes a display device 16. The display device 16 includes, for example, a liquid crystal display. The display device 16 displays various types of screens related to the functions that the image forming apparatus 1 is configured to perform. The operation device 15 also includes a touch panel 15B overlaid on the display device 16. The operation device 15 exemplifies the instruction input device in What is claimed is.

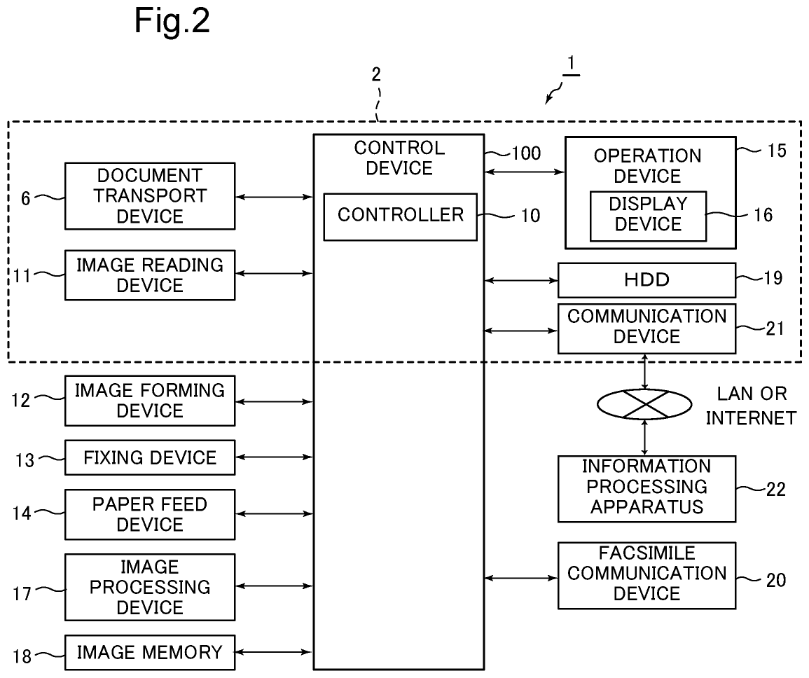

FIG. 2 is a block diagram showing an internal configuration of the image forming apparatus including the image reading apparatus according to the embodiment of the disclosure. As shown in FIG. 2, the image forming apparatus 1 includes a control device 100. The control device 100 includes a processor, a random-access memory (RAM), and a read-only memory (ROM). The processor may be, for example, a central processing unit (CPU), a microprocessing unit (MPU), or an application specific integrated circuit (ASIC). The control device 100 acts as a controller 10 when the processor executes a control program stored in the built-in ROM or a hard disk drive (hereinafter, HDD) 19.

The control device 100 is electrically connected to the document transport device 6, the image reading device 11, the image forming device 12, the fixing device 13, the paper feed device 14, the operation device 15, an image processing device 17, an image memory 18, the HDD 19, a facsimile communication device 20, and a communication device 21. In this embodiment, the document transport device 6, the image reading device 11, the operation device 15, the display device 16, the HDD 19, the communication device 21, and the control device 100 act as an image reading apparatus 2.

The controller 10 serves to control the overall operation of the image forming apparatus 1. To be more detailed, the controller 10 controls the operation of the functional devices of the image forming apparatus 1, and the communication with an information processing apparatus 22 such as a PC or a mail server connected via a network.

The image processing device 17 processes an image as required, with respect to the image data generated by the image reading device 11.

The image memory 18 includes a region for temporarily storing the image data to be printed, generated by the image reading device 11.

The HDD 19 is a large-capacity storage device for storing various types of data, including image files based on the image data generated by the image reading device 11. The HDD 19 also contains control programs for realizing the basic functions of the image forming apparatus 1. The HDD 19 exemplifies the storage device in What is claimed is.

The HDD 19 contains a transmission program for executing the e-mail transmission according to this embodiment. The processor acts, by operating in accordance with the transmission program, as the controller 10 to execute the e-mail transmission. The transmission program is one of the control programs.

The HDD 19 contains a known two-dimensional code reading program. The controller 10 operates according to the two-dimensional code reading program, to extract image data corresponding to the two-dimensional code (hereinafter, “code data”) from the image data generated by the image reading device 11, and acquire, for example, data indicating the e-mail address of the transmission source, through analysis of the code data extracted. Here, the type of the two-dimensional code is not specifically limited provided that the code is popularly used. For example, a quick response (QR) code (registered trademark) may be employed.

Here, the controller 10 may be constituted of hardware circuits to perform the operations, instead of being realized on the basis of the computer program. Alternatively, the controller 10 may be constituted of two or more control devices.

In the HDD 19, user names for identifying a user, and passwords respectively associated with the user names are stored in advance. The user registers the user name and the password in advance, through the operation device 15. In this embodiment, it will be assumed that a user name “AAA” and a password “123” associated with the user name are stored in advance in the HDD 19.

The facsimile communication device 20 realizes connection to the public telephone circuit, to transmit and receive the image data via the public telephone circuit.

The communication device 21 includes a communication module such as a local area network (LAN) board. The image forming apparatus 1 can perform data communication with the information processing device 22, such as a PC or a mail server on a network, through the communication device 21.

The functional devices of the image forming apparatus 1 are connected to a power source, to operate with the power supplied from the power source.

### Operation

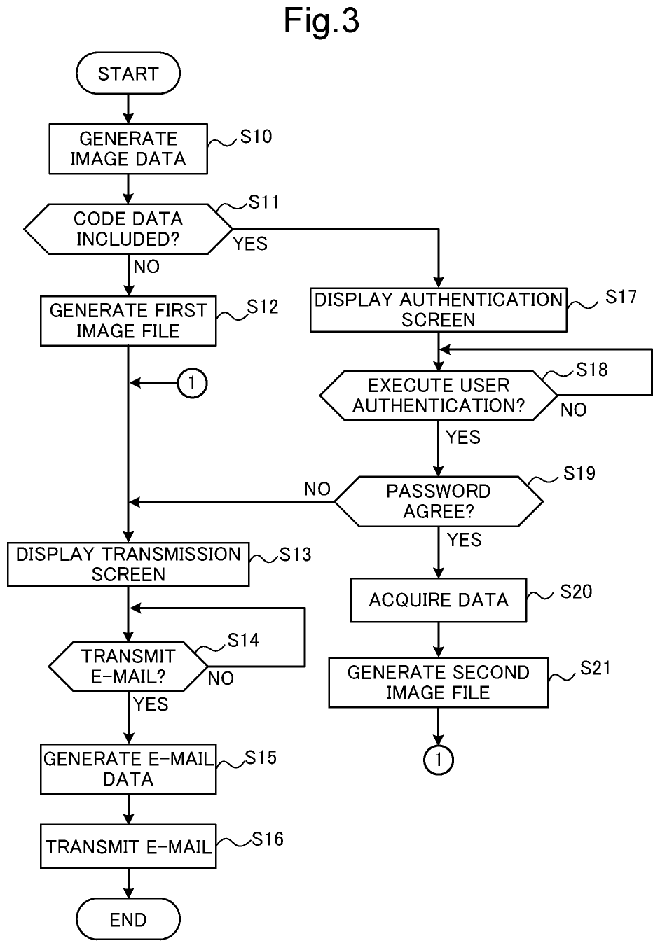

FIG. 3 is a flowchart showing an e-mail transmission process. Hereunder, the control process executed in the image forming apparatus 1 to execute the e-mail transmission will be described, along with the operation performed by the image forming apparatus 1. The transmission program is carried out by the controller 10, when the user selects the e-mail transmission function through the operation device 15, and inputs an instruction for the image reading device 11 to read a document.

When the power to the image forming apparatus 1 is turned on, the controller 10 causes the display device 16 to display a home screen, for selecting one of a plurality of functions that can be performed by the image forming apparatus 1.

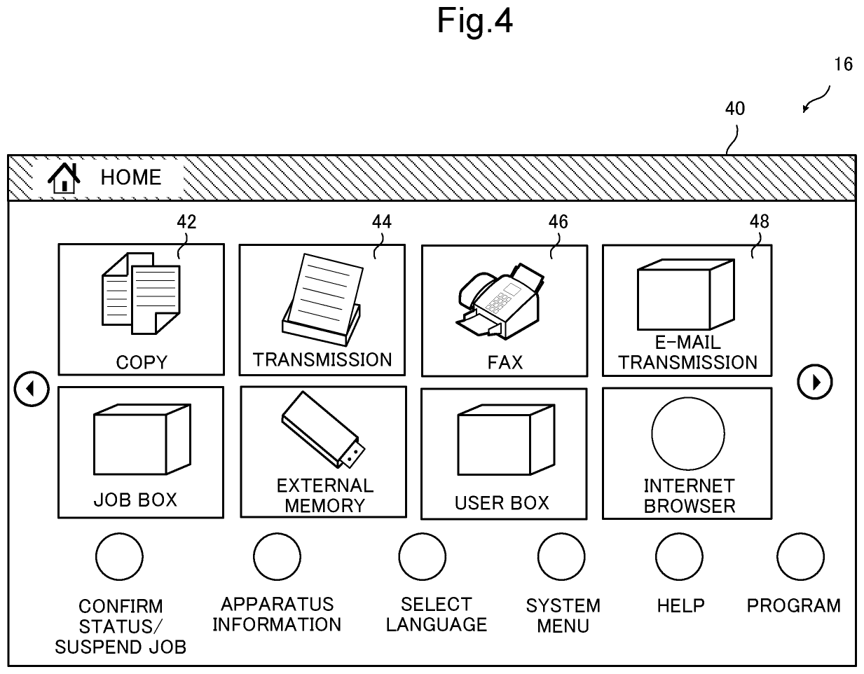

FIG. 4 illustrates an example of the home screen. As is apparent from FIG. 4, the home screen 40 is for selecting one of the plurality of functions that can be performed by the image forming apparatus 1. The home screen 40 includes, as soft keys, a key 42 for selecting the copying function, a key 44 for selecting the transmission function, a key 46 for selecting the facsimile function, and a key 48 for selecting the e-mail transmission function.

It will be assumed that the user has pressed, upon viewing the home screen 40, the key 48 with the intention to utilize the e-mail transmission function. Upon detecting through the touch panel 15B that the key 48 has been pressed, the controller 10 causes the display device 16 to display a non-illustrated setup screen, for the user to input the details about the image file to be transmitted.

It will be assumed that in view of the setup screen the user has designated, through the operation device 15, the portable document format (hereinafter, PDF) as the file format of the image file to be transmitted, and inputted a character string “meeting” as the file name of the image file. Upon receipt of the designation and the input, the controller 10 selects PDF as the file format of the image file, and sets the file name as “meeting”.

Further, it will be assumed that the user has already created a source document that is the origin of the image file to be transmitted, using a PC owned by the user. More specifically, the user creates the image file in PDF with the PC, and prints an image based on the created image file on a recording sheet, using the image forming device 12 of the image forming apparatus 1, thus obtaining the source document.

The user can also create the source document including a two-dimensional code indicating the e-mail information, as follows. To create the image file, the user causes the CPU of the PC to operate according to a known two-dimensional code generation program, to generate the code data indicating the e-mail address of the transmission source inputted in the PC by the user, the e-mail address of the destination, the title, and the body text. The user creates the image file, in which the code data generated as above is included in a footer region. In this embodiment, the footer region of the image file is an example of a predetermined region prepared for the two-dimensional code.

Hereunder, an operation of the image forming apparatus 1 will be described, with respect to the case where the source document is without the two-dimensional code, and the case where the source document includes the two-dimensional code.

1. When Source Document is without Two-Dimensional Code

The user places the source document on the platen glass of the image reading device 11. The source document on the platen glass does not include the two-dimensional code. After placing the source document, the user presses the start key 15A provided in the operation device 15, to cause the image reading device 11 to read the source document.

Referring to FIG. 3, upon detecting that the start key 15A has been pressed, the controller 10 causes the image reading device 11 to read the source document placed on the platen glass, and generate image data (step S10).

After the image data is generated, the controller 10 decides whether the generated image data includes code data corresponding to a two-dimensional code, using the two-dimensional code reading program stored in advance in the HDD 19 (step S11). More specifically, the controller 10 extracts image data in the predetermined region that may include the two-dimensional code, from the generated image data, and decides whether the extracted image data includes the code data.

Since the source document is without the two-dimensional code, the controller 10 decides that the image data does not include the code data (NO at step S11), and generates a first image file in PDF based on the image data generated as above (step S12). The first image file is stored in the HDD 19. The controller 10 sets the file name of the first image file as “meeting”.

After generating the first image file, the controller 10 causes the display device 16 to display a transmission screen for confirming the details of the e-mail (step S13).

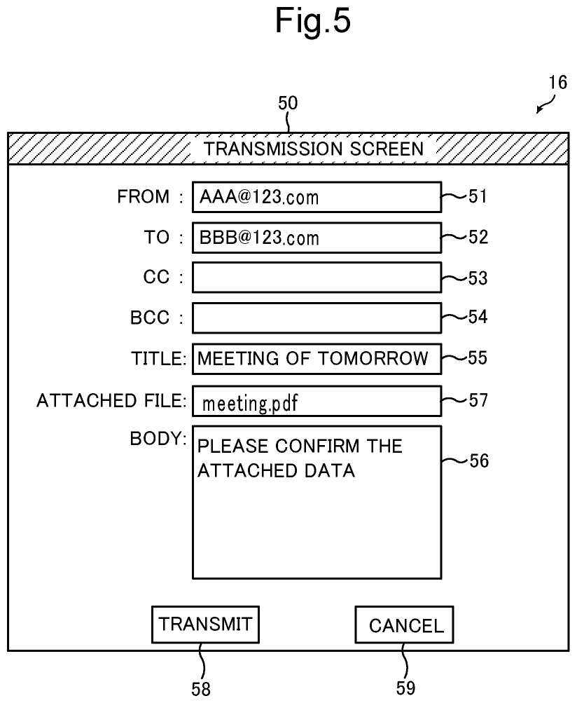

FIG. 5 illustrates an example of the display format of the transmission screen. As shown in FIG. 5, the transmission screen 50 includes a field 51 for displaying the e-mail address of the transmission source, a field 52 for displaying the e-mail address of the destination, a field 53 for displaying the e-mail address of a carbon copy (hereinafter, CC), a field 54 for displaying the e-mail address of a blind carbon copy (hereinafter, BCC), a field 55 for displaying the title, and a field 56 for displaying the body text. The field 51 to the field 56 each display the information inputted by the user through the operation device 15.

The transmission screen 50 also includes a field 57 for displaying the content of the attached file. In this example, the field 57 displays “meeting.pdf” representing the file name of the first image file. The transmission screen 50 further includes a key 58 for inputting an instruction to transmit the e-mail, and a key 59 for inputting an instruction to suspend the e-mail transmission, which are soft keys. After the transmission screen 50 is displayed, the controller 10 stands by for the instruction to transmit the e-mail (step S14).

As shown in FIG. 5, the user has inputted, through the operation device 15, “AAA@123.com” as the e-mail address of the transmission source, “BBB@123.com” as the e-mail address of the destination, “Meeting of tomorrow” as the title, and “Please confirm the attached data” as the body text.

The controller 10 causes the display device 16 to display the inputted e-mail address of the transmission source in the field 51, the inputted e-mail address of the destination in the field 52, the inputted title in the field 55, and the inputted body text in the field 56. The user confirms the field 51, the field 52, the field 55, and the field 56, and presses the key 58, leaving the field 53 and the field 54 blank.

Upon detecting through the touch panel 15B that the key 58 has been pressed, the controller 10 decides that the instruction to transmit the e-mail has been received (YES at step S14), and generates e-mail data (step S15). The e-mail data is generated, for example, in accordance with the provisions of the multipurpose Internet mail extension (MIME).

The controller 10 generates the e-mail data, from the data received through the operation device 15. More specifically, the controller 10 generates the e-mail data, such that the data indicating “AAA@123.com” which is the e-mail address of the transmission source, “BBB@123.com” which is the e-mail address of the destination, and “Meeting of tomorrow” which is the title, is included in a header region. In addition, the controller 10 generates the e-mail data, such that the data indicating “Please confirm the attached data” which is the body text, and the first image file which is the attached file, is included in the body region.

After generating the e-mail data, the controller 10 transmits the generated e-mail data through the communication device 21, to the e-mail address of the destination inputted through the operation device 15 (step S16). In this example, the controller 10 transmits the e-mail data to “BBB@123.com”, which is the e-mail address of the destination.

Thus, the e-mail data is transmitted to the e-mail address of the destination, through the mail server connected via the network.

### 2. When Source Document Includes Two-Dimensional Code

The user places the source document on the platen glass of the image reading device 11. The source document on the platen glass includes the two-dimensional code.

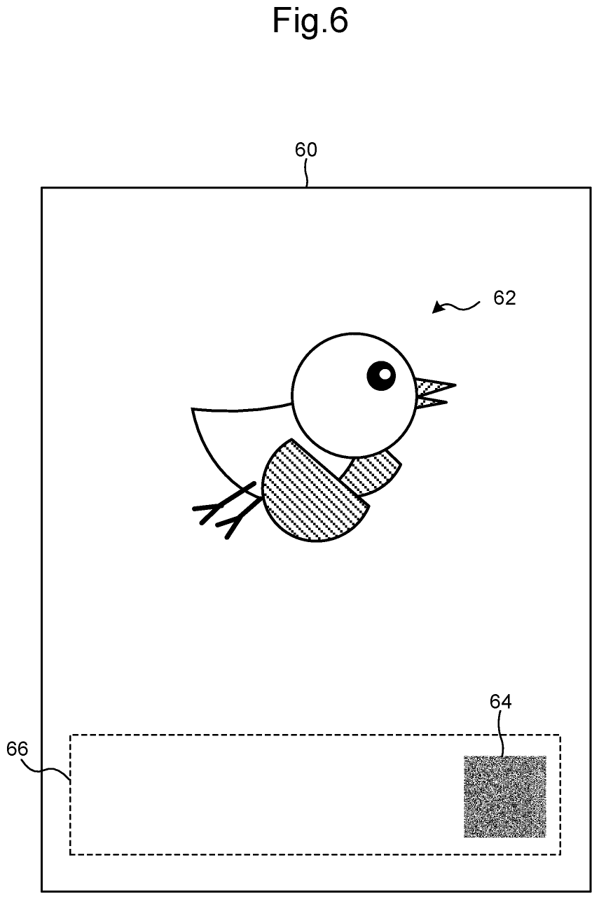

FIG. 6 illustrates an example of the source document that includes the two-dimensional code. As shown in FIG. 6, the source document 60 includes an image 62 to be transmitted, and a two-dimensional code 64. The two-dimensional code 64 is printed in a footer region 66 of the source document 60, which is the predetermined region prepared for the two-dimensional code. Here, the footer region 66 refers to, for example, a region provided as a footer region in the image file of PDF.

In this embodiment, the two-dimensional code 64 is created so as to indicate “AAA@123.com” representing the e-mail address of the transmission source, “CCC@123.com” representing the e-mail address of the destination, “DDD@123.com” representing the e-mail address of the CC, and “EEE@123.com” representing the e-mail address of the BCC. The two-dimensional code 64 is also created so as to indicate “Meeting of day after tomorrow” representing the title, and “Please confirm the attached data” representing the body text.

After placing the source document, the user presses the start key 15A provided in the operation device 15, to cause the image reading device 11 to read the source document. Referring again to FIG. 3, upon detecting that the start key 15A has been pressed, the controller 10 causes the image reading device 11 to read the source document placed on the platen glass, and generate image data (step S10).

After the image data is generated, the controller 10 decides whether the generated image data includes code data corresponding to a two-dimensional code, using the two-dimensional code reading program stored in advance in the HDD 19 (step S11). More specifically, the controller 10 extracts image data in the portion corresponding to the footer region 66, from the generated image data. For example, the controller 10 extracts the image data in the portion corresponding to the footer region, in the image of the source document represented by the image data. Then the controller 10 decides whether the extracted image data includes the code data. Since the controller 10 extracts the image data in the portion corresponding to the predetermined region, in other words the footer region, whether the code data is included can be more rapidly and efficiently decided, compared with the case of extracting the entire region of the source document.

Since the footer region 66 of the source document 60 includes the two-dimensional code 64 in this example, the controller 10 decides that the image data includes the code data (YES at step S11), and causes the display device 16 to display an authentication screen for executing the user authentication (step S17).

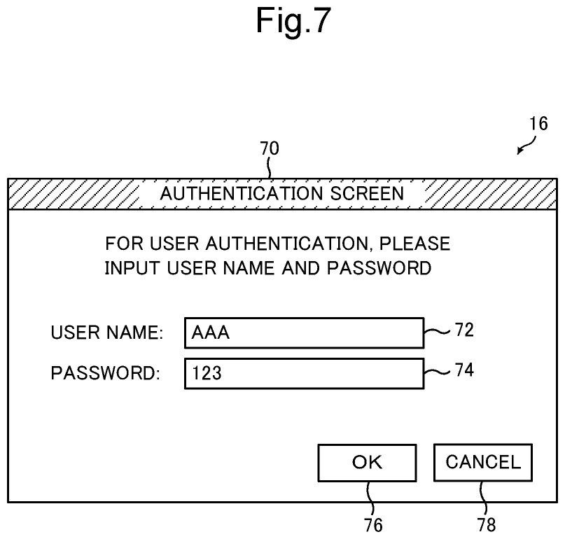

FIG. 7 illustrates an example of the authentication screen. As shown in FIG. 7, the authentication screen 70 includes a field 72 for displaying the inputted user name, and a field 74 for displaying the inputted password. The authentication screen 70 also includes, as soft keys, a key 76 for inputting an instruction to execute the user authentication, and a key 78 for inputting an instruction to suspend the e-mail transmission. After the authentication screen 70 is displayed, the controller 10 stands by for the instruction to execute the user authentication (step S18).

As shown in FIG. 7, the user has inputted, through the operation device 15, “AAA” as user name, and “123” as the password. The controller 10 causes the display device 16 to display the inputted user name in the field 72, and the inputted password in the field 74. Upon confirming the display in the field 72 and the field 74, the user presses the key 76.

Upon detecting through the touch panel 15B that the key 76 has been pressed, the controller 10 decides that the instruction to execute the user authentication has been received (YES at step S18), and decides whether the inputted password accords with the password stored in the HDD 19 in association with the inputted user name (step S19).

In this example, the controller 10 decides that the inputted password accords with the password stored in the HDD 19 in association with the inputted user name (YES at step S19), and analyzes the code data included in the image data using the two-dimensional code reading program stored in advance in the HDD 19, thereby acquiring the data indicating the e-mail address of the transmission source, the e-mail address of the destination, the title, and the body text, from the code data (step S20).

After acquiring the mentioned data, the controller 10 deletes the code data from the image data, thus to generate a second image file in PDF based on the image data, from which the code data has been deleted, and stores the second image file in the HDD 19 (step S21). At this point, the controller 10 sets the file name of the second image file as “meeting”, as originally set.

After generating the second image file, the controller 10 causes the display device 16 to display the transmission screen 50 (step S13). In this process, the controller 10 causes the display device 16 to display the transmission screen 50, with the e-mail address of the transmission source, the e-mail address of the destination, the title, and the body text, which were acquired from the code data, displayed in the corresponding fields.

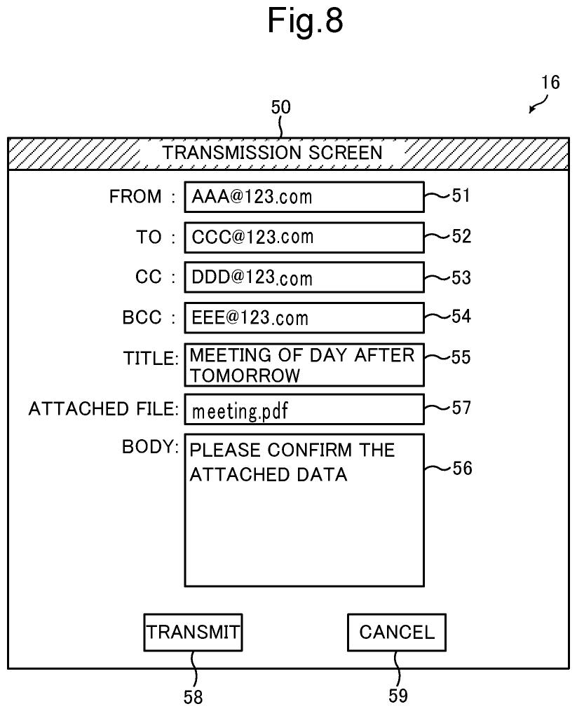

FIG. 8 illustrates another example of the display format of the transmission screen. In the example shown in FIG. 8, the controller 10 causes the display device 16 to display, as the data acquired from the code data, “AAA@123.com” representing the e-mail address of the transmission source in the field 51, “CCC@123.com” representing the e-mail address of the destination in the field 52, “DDD@123.com” representing the e-mail address of the CC in the field 53, “EEE@123.com” representing the e-mail address of the BCC in the field 54, “Meeting of day after tomorrow” representing the title in the field 55, “Please confirm the attached data” representing the body text in the field 56, and “meeting.pdf” representing the content of the second image file, in the field 57.

The user confirms the transmission screen 50, on which the data acquired from the code data is displayed, and presses the key 58. Upon detecting through the touch panel 15B that the key 58 has been pressed, the controller 10 decides that the instruction to transmit the e-mail has been received (YES at step S14), and generates e-mail data (step S15).

In this example, the controller 10 generates the e-mail data, from the data acquired from the code data. More specifically, the controller 10 generates the e-mail data, such that the data indicating “AAA@123.com” which is the e-mail address of the transmission source, “CCC@123.com”, “DDD@123.com”, and “EEE@123.com” which are the respective e-mail addresses of the destinations, and “Meeting of day after tomorrow” which is the title, is included in the header region. In addition, the controller 10 generates the e-mail data, such that the data indicating “Please confirm the attached data” which is the body text, and the second image file which is the attached file, is included in the body region.

After generating the e-mail data, the controller 10 transmits the generated e-mail data to the respective e-mail addresses of the destinations acquired from the code data, through the communication device 21 (step S16). In this example, the controller 10 transmits the e-mail data to “CCC@123.com” which is the e-mail address of the destination, “DDD@123.com” which is the e-mail address of the CC, and “EEE@123.com” which is the e-mail address of the BCC.

Thus, the e-mail data is transmitted to the e-mail address of the destination, through the mail server connected via the network.

On the contrary, in the case where the controller 10 decides that the inputted password does not accord with the password stored in the HDD 19 in association with the inputted user name (NO at step S19), the controller 10 performs the operations from step S13 to step S16, as described earlier. In this case, the controller 10 causes the display device 16 to display the transmission screen 50 leaving the fields 51 to 56 blank, at step S13.

Here, when the key 59 in the transmission screen 50 or the key 78 in the authentication screen 70 is pressed by the user, the controller 10 finishes the e-mail transmission process. After finishing the e-mail transmission process, the controller 10 causes the display device 16 to display the home screen 40.

As described above, when the image data generated by the image reading device 11 includes the code data corresponding to the two-dimensional code indicating the destination of the image file, the controller 10 deletes the code data from the image data thereby generating the second image file, and transmits the second image file through the communication device 21, to the destination indicated by the two-dimensional code, and acquired from the code data.

The mentioned arrangement allows the user to transmit the image file generated through the scanning function to the desired destination, simply by including the two-dimensional code in the source document, without the need to input the destination through the operation device 15. Therefore, the user can be exempted from the trouble and time required to input the destination of the image file. In addition, since the image file from which the code data has been deleted is transmitted, leakage of information from the code data can be prevented, and the image file can be transmitted under high security.

When the code data is not included in the image data generated by the image reading device 11, the controller 10 generates the first image file based on the image data, and transmits the first image file to the destination inputted through the operation device 15, through the communication device 21.

Thus, the user can also designate the destination of the image file, by inputting the destination through the operation device 15. Therefore, the convenience in use for the user can be further improved.

Further, when the two-dimensional code indicates the e-mail address as the destination of the image file, the controller 10 generates the e-mail data including the data indicating the e-mail address of the destination in the header region, and the data indicating the second image file in the body region, and transmits the e-mail data to the e-mail address acquired from the code data, through the communication device 21.

The mentioned arrangement allows the user to transmit the image file generated through the scanning function to the desired e-mail address, simply by including the two-dimensional code in the source document, without the need to input, through the operation device 15, the e-mail address of the destination, and other destinations such as the e-mail address of the CC or BCC that may be optionally designated. Therefore, the trouble and time imposed on the user to input the destination of the image file can be further minimized.

Still further, when the two-dimensional code also represents the body text, the controller 10 generates the e-mail data in which the body region further includes the data indicating the body text, and transmits the e-mail data to the e-mail address acquired from the code data, through the communication device 21.

When an image file generated through the scanning function is attached to an e-mail for transmission, the e-mail data is often transmitted without the body text, because it is troublesome to input data through the operation device 15. With the arrangement according to the foregoing embodiment, however, the user can transmit the e-mail data, in which the body region includes the data representing the image file generated through the scanning function and the body text, to the desired e-mail address, simply by including the two-dimensional code in the source document, without the need to input the body text through the operation device 15. Therefore, the user can be exempted from the trouble and time required to input the body text.

According to the embodiment, when the image data generated by the image reading device 11 includes the code data, and the password inputted through the operation device 15 accords with the password stored in advance in the HDD 19 in association with the user name inputted through the operation device 15, the controller 10 transmits the second image file to the destination acquired from the code data, through the communication device 21. On the other hand, when the image data generated by the image reading device 11 includes the code data, and the password inputted through the operation device 15 does not accord with the password stored in advance in the HDD 19 in association with the user name inputted through the operation device 15, the controller 10 does not transmit the second image file.

The mentioned arrangement allows only the user who has inputted the user name and the password that are registered in advance, to transmit the image file to the destination acquired from the code data. Therefore, the destination indicated by the two-dimensional code can be prevented from being utilized, for example by a third party who has maliciously acquired the two-dimensional code, and the image file can be transmitted under even higher security.

Now, when an image file generated through the scanning function is to be transmitted, the user has to input the destination of the image file, for example through the operation device, which requires trouble and time. In particular, when an e-mail is to be transmitted with the image file attached thereto, the user has to input the e-mail information such as the e-mail address of the destination, the e-mail address of the CC or BCC that may be optionally designated, the title, and so forth, and therefore the trouble and time for inputting the information imposed on the user are increased.

With the existing technique according to the foregoing background art, the user inputs the e-mail information, for example using soft keys on the operation panel, and therefore the mentioned drawbacks remain unsolved.

In contrast, the arrangement according to the above embodiment minimizes the trouble and time imposed on the user, to input the destination of the image file, for example through the operation device.

### Variations

Although the controller 10 is configured to execute the user authentication using the user name and the password stored in the HDD 19 in the foregoing embodiment, different methods may be adopted. For example, the two-dimensional code may be created so as to indicate the user name and the password in addition to the e-mail information, and the controller 10 may execute the user authentication using the user name and the password acquired from the two-dimensional code.

It is preferable to encrypt the user name and the password represented by the two-dimensional code. In this case, upon acquiring the encrypted user name and password from the code data, the controller 10 decrypts the user name and the password using a decryption program stored in advance in the HDD 19, and executes the user authentication using the decrypted user name and password.

Although the two-dimensional code is employed as an example of the code in the foregoing embodiment, different types of code may be employed. The type of the code is not specifically limited provided that the code can represent the destination of the image file, and for example a one-dimensional bar code may be employed.

Although the e-mail address is utilized as the destination of the image file in the foregoing embodiment, the disclosure is not limited to such arrangement. For example, a directory path indicating the folder in which the image file is stored, may be adopted as the destination of the image file. In this case, the controller 10 stores the first image file or the second image file in the folder indicated by the directory path.

According to the foregoing embodiment, the two-dimensional code 64 is created so as to indicate the e-mail address of the transmission source, the e-mail address of the destination, the title, and the body text. However, the disclosure is not limited to such arrangement. It suffices that the two-dimensional code includes at least the information indicating the destination.

For example, the two-dimensional code may be created so as to indicate only the e-mail address of the destination and the body text. In this case, the controller 10 causes the display device 16, at step S13, to display the transmission screen 50 in which the data acquired from the two-dimensional code is displayed only in the field 52 and the field 56. The user may input data in the field 53, the field 54, or the field 55 through the operation device 15 if need be, and press the key 58.

Alternatively, the two-dimensional code may be created so as to indicate only the e-mail address of the destination, the title, and the body text. In this case, the controller 10 causes the display device 16, at step S13, to display the transmission screen 50 in which the data acquired from the two-dimensional code is displayed only in the field 52, the field 55, and the field 56. The user may input data in the field 53 or the field 54 through the operation device 15 if need be, and press the key 58.

Although the e-mail address of the transmission source is either indicated by the two-dimensional code 64, or inputted by the user through the operation device 15 in the foregoing embodiment, the disclosure is not limited to such arrangement. For example, the e-mail address of the transmission source may be registered in advance, for example by an input by the user through the operation device 15, and stored in the HDD 19. In this case, the controller 10 causes the display device 16 to display the transmission screen 50 with the e-mail address of the transmission source, registered in advance, displayed in the field 51.

Further, although the footer region is prepared for the two-dimensional code in the foregoing embodiment, different arrangements may be adopted. For example, the header region of the source document, the back surface of the source document, a predefined left margin or right margin, or the both, of the source document may be prepared for the two-dimensional code.

Further, although the user name is utilized as the user information in the foregoing embodiment, different arrangements may be adopted. The user information is not specifically limited provided that the information allows the user to be identified, and may be, for example, the employee number.

Still further, the controller 10 is configured to generate the image file in PDF from the image data in the foregoing embodiment, different arrangements may be adopted. For example, the controller 10 may generate the image file in the tagged image file format (TIFF), or in the joint photographic experts group (JPEG).

Still further, although the e-mail data is generated in accordance with the provisions of MIME in the foregoing embodiment, different arrangements may be adopted. For example, the controller 10 may generate the e-mail data including the data indicating the e-mail address and the data indicating the body text, and transmit such e-mail data to the destination indicated by the e-mail address, together with the first or second image file, through the communication device 21.

The disclosure is not limited to the foregoing embodiment, but may be modified in various manners. For example, although the image reading apparatus according to the disclosure is exemplified by a color multifunction peripheral in the foregoing embodiment, the disclosure is broadly applicable to other types of electronic apparatuses, such as a monochrome multifunction peripheral, a copier, and a facsimile machine.

Further, the configurations and arrangements according to the foregoing embodiments and variations, described with reference to FIG. 1 to FIG. 8, are merely exemplary, and in no way intended to limit the disclosure to those configurations and arrangements.

While the present disclosure has been described in detail with reference to the embodiments thereof, it would be apparent to those skilled in the art the various changes and modifications may be made therein within the scope defined by the appended claims.

What is claimed is:

1. An image reading apparatus comprising:
an image reading device that reads a source document and generates image data;
a communication device that communicates with an information processing apparatus via a network; and
a control device including a processor, and configured to act as a controller that generates a first image file based on the image data, when the processor executes a control program,
wherein, when the image data includes code data corresponding to a code indicating a destination of the image file, the controller generates a second image file by deleting the code data from the image data, and transmits the second image file to the destination indicated by the code, and acquired from the code data, through the communication device.

2. The image reading apparatus according to claim 1, further comprising an input device for a user to input the destination of the image file,
wherein, when the image data is without the code data, the controller generates the first image file based on the image data, and transmits the first image file through the communication device, to the destination received through the input device.

3. The image reading apparatus according to claim 1,
wherein, when the code indicates an e-mail address as the destination of the image file, the controller generates e-mail data including data indicating the e-mail address of the destination in a header region, and data indicating the second image file in a body region, and transmits the e-mail data to the e-mail address acquired from the code data, through the communication device.

4. The image reading apparatus according to claim 3,
wherein, when the code also indicates a body text, the controller generates the e-mail data in which the body region further includes data indicating the body text, and transmits the e-mail data to the e-mail address acquired from the code data, through the communication device.

5. The image reading apparatus according to claim 1, further comprising:
a storage device in which user information for identifying a user, and a password associated with the user information are stored; and
an input device for inputting the user information and the password,
wherein, when the image data includes the code data, and the password inputted through the input device accords with the password stored in advance in the storage device in association with the user information inputted through the input device, the controller transmits the second image file to the destination acquired from the code data, through the communication device, and
when the image data includes the code data, and the password inputted through the input device disaccords with the password stored in advance in the storage device in association with the user information inputted through the input device, the controller keeps from transmitting the second image file.

6. The image reading apparatus according to claim 1,
wherein the controller extracts image data in a portion corresponding to a footer region, in the image of the source document represented by the image data, and decides whether the extracted image data includes the code data.

7. The image reading apparatus according to claim 1, further comprising a display device,
wherein, after generating the second image file, the controller causes the display device to display the destination indicated by the code, and acquired from the code data, and transmits the second image file to the destination, upon receipt of an instruction to transmit the second image file.
